(19) United States
(12) Patent Application Publication
(10) Pub. No.: US 2010/0125678 A1
(43) Pub. Date: May 20, 2010

(54) ELECTRONIC DEVICE AND RELATED METHOD FOR CONTROLLING A PERIPHERAL DEVICE

(76) Inventors: Po-Hsu Chen, Taipei Hsien (TW); Bor-Lun Chang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/475,584

(22) Filed: May 31, 2009

(30) Foreign Application Priority Data
Nov. 18, 2008 (TW) 097144532

(51) Int. Cl. G06F 3/00

(52) U.S. Cl. 710/5; 710/16

(57) ABSTRACT

An electronic device for controlling a peripheral device includes a data processing unit for receiving a control command and transforming the control command into a first command, a command processing unit coupled to the data processing unit, for decoding the first command to obtain a task of the peripheral device and encoding the task to generate a second command, and a transformation unit coupled to the command processing unit and the peripheral device, for transforming the second command into a third command of a consumer electronic control format, for controlling operations of the peripheral device.

### BACKGROUND OF THE INVENTION

1. Field of the Invention

The present invention relates to an electronic device and related method for controlling a peripheral device, and more particularly, to an electronic device and related method for controlling a peripheral device by a HDMI-CEC (High Definition Multimedia Interface-Consumer Electronic Control) signal.

2. Description of the Prior Art

With the development of computer and communications network technologies, digital home appliances are getting popular and bring great convenience to people in modern life. A digital home integrates the control of personal computers, multimedia entertainment equipment, home electronics such as a refrigerator and a washing machine, and a security system. These digital home appliances are connected to a home gateway through wired/wireless network and communicate with the external network by the home gateway. In a digital home, people perform remote control on digital home appliances, for example, control the angle of a door monitoring system or set the temperature and operation time of an air conditioner, even if they are not home.

Please refer to FIG. 1, which is a block diagram of a digital home 10 according to the prior art. The digital home 10 comprises a router 100, a DVD player 102, a computer 104, an access point 106, and an Infrared (IR) transmitter 108. The peripheral device in the digital home 10, such as the DVD player 102, is connected to the access point (AP) 106 via the IR transmitter 108. The access point 106 and the computer 104 are connected with the Internet via the router 100. The access point 106 uses a networking protocol as Transmission Control Protocol/Internet Protocol (TCP/IP) to control a connected peripheral device of high complexity, such as a computer, and control another peripheral device of low complexity, such as the DVD player 102, a television or a set-up box, via the IR transmitter 108. Note that the IR transmitter 108 can only transmit signals with a single direction and cannot transmit an acknowledge as a response, which means that the access point 106 has no way to recognize whether a transmitted command is successfully received by the DVD player 102 after sending the command, and thereby cannot perform a preferable control according to a response signal.

Currently, general peripheral devices do not support a high-level protocol as TCP/IP. The user can only perform remote control on those peripheral devices in the digital system 10 via the access point 106 and cannot directly control the peripheral devices. In other words, a general peripheral device cannot perform the control integration like the access point 106 does, which is inconvenient and inflexible in the digital home.

### SUMMARY OF THE INVENTION

It is therefore a primary objective of the claimed invention to provide an electronic device and related method for controlling a peripheral device.

The present invention discloses an electronic device for controlling a peripheral device, the electronic device comprising a data processing unit, a command processing unit, and a transformation unit. The data processing unit is utilized for receiving a control command and transforming the control command into a first command. The command processing unit is coupled to the data processing unit and is utilized for decoding the first command to obtain a task of the peripheral device and encoding the task for generating a second command. The transformation unit is coupled to the command processing unit and the peripheral device, and is utilized for transforming the second command into a third command of CEC format, for controlling operations of the peripheral device.

The present invention further discloses a control method for controlling a peripheral device, the control method comprising receiving a control command and transforming the control command into a first command, decoding the first command to obtain a task of the peripheral device and encoding the task to generate a second command, and transforming the second command into a third command of CEC format, for controlling operations of the peripheral device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a digital home according to the prior art.

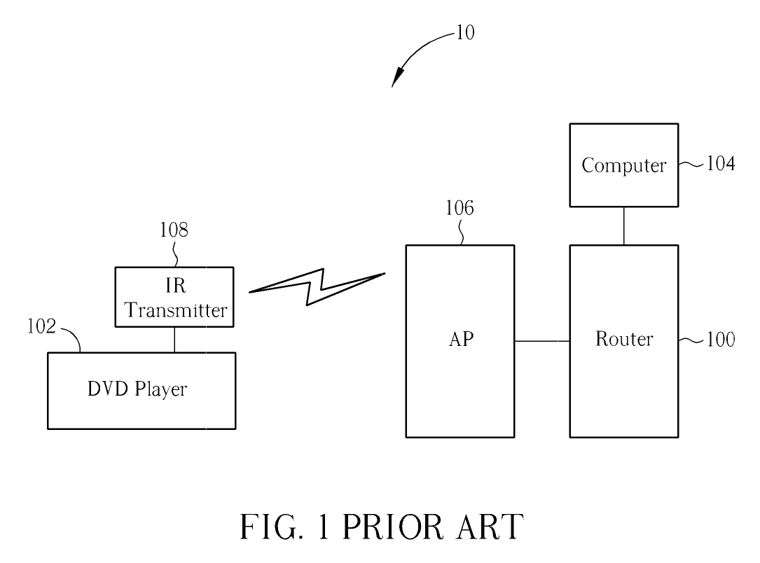

FIG. 2 is a block diagram of an electronic device according to an embodiment of the present invention.

FIG. 3 is a block diagram of a digital home according to an embodiment of the present invention.

FIG. 4 is a flowchart of a process according to an embodiment of the present invention.

### DETAILED DESCRIPTION

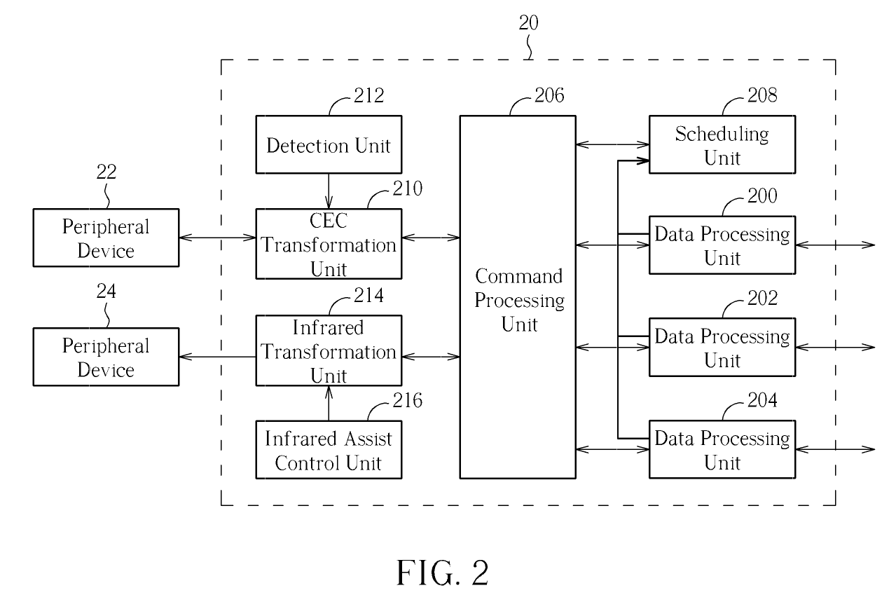

Please refer to FIG. 2, which is a block diagram of an electronic device 20 according to an embodiment of the present invention. The electronic device 20 is utilized for controlling multiple peripheral devices located in a region, such as a television, a DVD player, a digital video recorder, a personal video recorder, and a set-up box. First note that, the present invention uses a HDMI-CEC (High Definition Multimedia Interface-Consumer Electronic Control) signal to control peripheral devices, which means that the electronic device 20 controls those peripheral devices supporting HDMI.

Briefly, the electronic device 20 is utilized for receiving a control command generated by a control device such as a computer, a mobile phone or a telephone, transforming the control command into a CEC command, and controlling a peripheral device accordingly. For example, a user uses a computer located outside of the home to connect to the electronic device 20 at home, for controlling a video recorder to record programs. In this situation, the electronic device 20 receives a control command generated by the computer and controls the video recorder according a CEC command transformed from the control command. The embodiment of the present invention only describes that the electronic device 20 receives one control command from a peripheral device 22; in fact, the electronic device 20 can receive multiple control commands and control multiple peripheral devices respectively.

The electronic device 20 comprises data processing units 200, 202 and 204, a command processing unit 206, a scheduling unit 208, a CEC transformation unit 210, a detection unit 212, an infrared transformation unit 214, and an infrared assist control unit 216. The data processing units 200, 202 and 204 are utilized for transforming control commands of different formats respectively such that a control command is transformed into a command with a specific format, called the first command later. The specific format is acceptable for the command processing unit 206 and is different depending on types of the corresponding control device. The data processing unit 200 is utilized for transforming a control command of Transmission Control Protocol/Internet Protocol (TCP/IP) format. The data processing unit 202 is utilized for transforming a control command of Hypertext Transfer Protocol (HTTP) (or Hypertext Transfer Protocol over Secure Socket Layer, HTTPS) format. When the user uses a mobile phone or a computer to connect to the electronic device 20 via the Internet, the data processing unit 200 or 202 receives the control command of TCP/IP format or HTTP/HTTPS format and transforms the control command. The data processing unit 204 is utilized for transforming the control command which is audio data generated by a telephone. The command processing unit 206 is coupled to the data processing unit 200, 202 and 204, and is utilized for decoding the first command to obtain a task of the peripheral device 22 and encoding the task to generate another command, called a second command later.

Note that the data processing units 200, 202 or 204 also sends the generated first command to the scheduling unit 208. The scheduling unit 208 is coupled to the data processing units 200, 202, 204 and the command processing unit 206. When there is timing information included in the control command, scheduling unit 208 assists the command processing unit 206 in processing the first command according to the timing information. For example, when the user uses the computer to transmit the control command of TCP/IP format to the electronic device 20, for controlling a video recorder at home to record a TV program at 6 pm; in this situation, the scheduling unit 208 assists the command processing unit 206 to process the first command, so that the video recorder is waken up on time for the recording task.

As mentioned previously, the command processing unit 206 encodes the task of the peripheral device 22 to generate the second command. The CEC transformation unit 210 is coupled to the command processing unit 206 and the peripheral device 22, and is utilized for transforming the second command generated by the command processing unit 206 into a CEC command, called the third command later, for controlling operations of the peripheral device 22 according to the third command. The detection unit 212 is coupled to the CEC transformation unit 210 and is utilized for assisting the CEC transformation unit 210 to complete a handshaking process to establish a connection with the peripheral device 22. Besides, the detection unit 212 automatically detects an operation state of the peripheral device 22 via the CEC transformation unit 210. If the electronic device 20 is coupled to multiple peripheral devices, the detection unit 212 can detect operation states of all peripheral devices. Furthermore, the CEC transformation unit 210 sends the detected operation state back to the command processing unit 206. The command processing unit 206 controls a corresponding data process unit to generate data related to the operation state and sends the data back to the control device. Therefore, the user knows the current operation state of the peripheral device 22 and can make a further decision accordingly.

Besides, the infrared transformation unit 214 and the infrared assist control unit 216 are utilized for controlling those peripheral devices not supporting HDMI and only controlled by an IR transmitter, as shown as a peripheral device 24 in FIG. 2. The infrared transformation unit 214 is coupled to the command processing unit 206 and the peripheral device 24, and is utilized for transforming the second command into an IR control command and controlling a handshaking process to establish a connection with the peripheral device 24. The infrared assist control unit 216, in which several IR control commands for different types of peripheral devices are stored, is coupled to the infrared transformation unit 214 and is utilized for assisting the infrared transformation unit 214 to transform the second command into the IR control command.

Note that, the electronic device 20 is one of embodiments of the present invention, and those skilled in the art can make alterations and modifications accordingly. The IR transmitter may not be supported by another embodiment not including the infrared transformation unit 214 and the infrared assist control unit 216. In addition, the data processing units 200, 202 and 204 can be integrated into a single data processing unit, and can support another format except TCP/IP and HTTP/HTTPS format. In a conventional digital home, the user remote controls peripheral devices, such as multimedia entertainment equipment, only through an access point and has no way to control the peripheral devices by a general peripheral device. Compared with the prior art, the electronic device 20 transforms the control command into the CEC command to control the peripheral device supporting HDMI, so that whether the electronic device 20 is independent or is installed in a peripheral device, the user can perform remote control on the peripheral devices in a digital home.

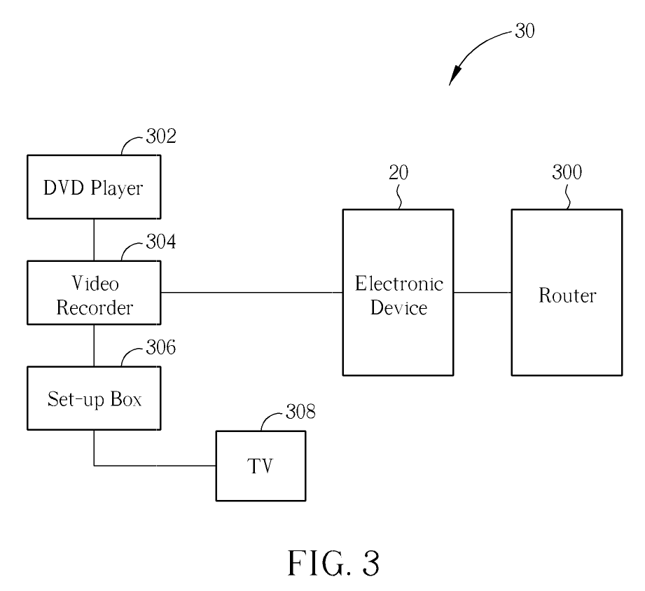

Please refer to FIG. 3, which is a block diagram of a digital home 30 according to an embodiment of the present invention. The digital home 30 comprises the electronic device 20, a router 300, a DVD player 302, a video recorder 304, a set-up box 306, and a television 308. The DVD player 302, the video recorder 304, the set-up box 306 and the television 308 are communicated with each other by HDMI CEC signals. The electronic device 20 is coupled to the router 300 and the video recorder 304, which is connected with the Internet via the router 300, and controls the peripheral devices as the DVD player 302, the set-up box 306 and the television 308, via the video recorder 304. By HDMI-CEC signal, the electronic device according to the present invention can control a peripheral device through another peripheral device, which enhances the user convenience of a digital home.

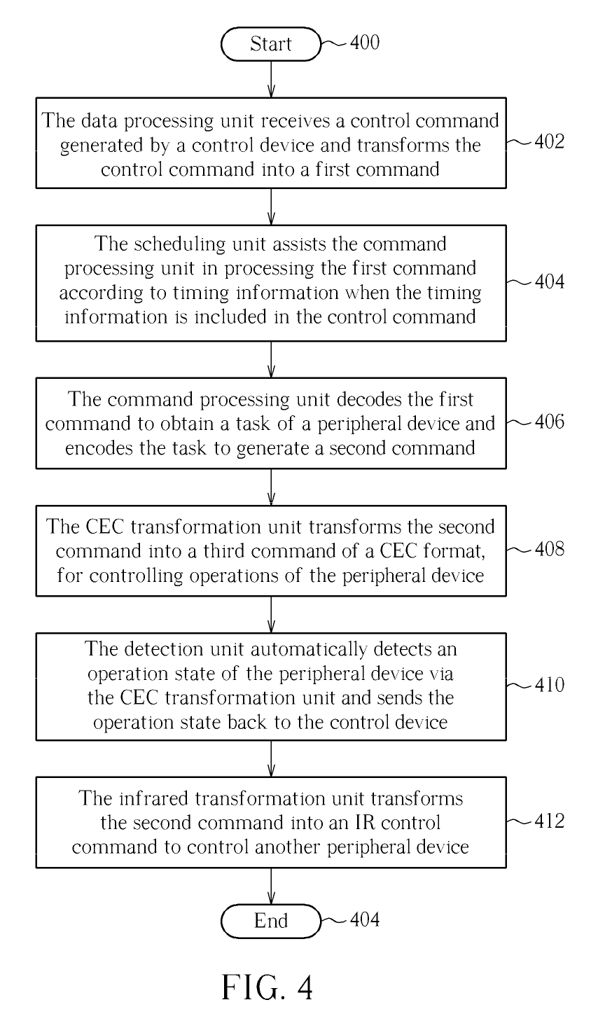

Please refer to FIG. 4 for the operations of the electronic device 20, which is a flowchart of a process 40 according to an embodiment of the present invention. The process 40 comprises the following steps:

Step 400: Start.

Step 402: The data processing unit 200, 202 or 204 receives a control command generated by a control device and transforms the control command into a first command.

Step 404: The scheduling unit 208 assists the command processing unit 206 in processing the first command according to timing information when the timing information is included in the control command.

Step 406: The command processing unit 206 decodes the first command to obtain a task of the peripheral device 22 and encodes the task to generate a second command.

Step 408: The CEC transformation unit 210 transforms the second command into a third command of a CEC format, for controlling operations of the peripheral device 22.

Step 410: The detection unit 212 automatically detects an operation state of the peripheral device 22 via the CEC transformation unit 210 and sends the operation state back to the control device.

Step 412: The infrared transformation unit 214 transforms the second command into an IR control command to control the peripheral device 24.

Step 414: End.

In the process 40, the control commands of different formats are transformed by the data processing unit 200, 202 or 204, for generating the first command sent to the command processing unit 206. Step 408 and Step 410 illustrate operations of the CEC transformation unit 210 and the detection unit 212; Step 412 illustrates operations of the infrared transformation unit 214. Step 408 and Step 412 can be operated at the same time. The operation of the process is described in detail in the electronic device 20 mentioned previously, which is not repeated.

In conclusion, the electronic device according to the present invention transforms the control command into the command of HDMI-CEC format through the data processing unit, the command processing unit and the CEC transformation unit, and thereby controls the peripheral device according to the command of HDMI-CEC format. The user only requires connecting the electronic device in order to control the peripheral devices in the digital home. Therefore, the user experience of the digital home is greatly improved.

Those skilled in the art will readily observe that numerous modifications and alterations of the device and method may be made while retaining the teachings of the invention.

What is claimed is:

1. An electronic device for controlling a peripheral device, the electronic device comprising:
a data processing unit for receiving a control command and transforming the control command into a first command;
a command processing unit coupled to the data processing unit, for decoding the first command to obtain a task of the peripheral device and encoding the task for generating a second command; and
a transformation unit coupled to the command processing unit and the peripheral device, for transforming the second command into a third command of consumer electronic control (CEC) format, for controlling operations of the peripheral device.

2. The electronic device of claim 1, wherein the control command is a remote control command.

3. The electronic device of claim 1, wherein the data processing unit is utilized for transforming the control command of Transmission Control Protocol/Internet Protocol (TCP/IP) format into the first command.

4. The electronic device of claim 1, wherein the data processing unit is utilized for transforming the control command of Hypertext Transfer Protocol (HTTP) format or Hypertext Transfer Protocol over Secure Socket Layer (HTTPS) format into the first command.

5. The electronic device of claim 1, wherein the control command is sent by a control device as a computer, a telephone, or a mobile communication device.

6. The electronic device of claim 5, wherein the data processing unit is utilized for transforming the control command which is audio data generated by the telephone into the first command.

7. The electronic device of claim 1 further comprising a scheduling unit coupled to the data processing unit and the command processing unit, for assisting the command processing unit in processing the first command according to timing information when the timing information is included in the control command.

8. The electronic device of claim 1 further comprising a detection unit coupled to the transformation unit, for automatically detecting an operation state of the peripheral device via the transformation unit.

9. The electronic device of claim 8, wherein the transformation unit is further utilized for sending the detected operation state of the peripheral device back to a control device sending the control command.

10. The electronic device of claim 1 further comprising an infrared transformation unit coupled to the command processing unit, for transforming the second command into an infrared control command, for controlling another peripheral device.

11. The electronic device of claim 10 further comprising an infrared assist control unit coupled to the infrared transformation unit, for assisting the infrared transformation unit to transform the second command.

12. A control method for controlling a peripheral device, the control method comprising:
receiving a control command and transforming the control command into a first command;
decoding the first command to obtain a task of the peripheral device and encoding the task to generate a second command; and
transforming the second command into a third command of consumer electronic control (CEC) format, for controlling operations of the peripheral device.

13. The control method of claim 12, wherein the control command is a command of Transmission Control Protocol/Internet Protocol (TCP/IP) format.

14. The control method of claim 12, wherein the control command is a command of Hypertext Transfer Protocol (HTTP) format or Hypertext Transfer Protocol over Secure Socket Layer (HTTPS) format.

15. The control method of claim 12, wherein the control command is audio data generated by a telephone.

16. The control method of claim 12 further comprising processing the first command according to timing information when the timing information is included in the control command.

17. The control method of claim 12 further comprising transforming the second command into an infrared control command, for controlling another peripheral device.

18. The control method of claim 12, wherein the control command is sent by a control device as a computer, a telephone, or a mobile communication device.
